(19) United States
(12) Patent Application Publication
(10) Pub. No.: US 2007/0180265 A1
(43) Pub. Date: Aug. 2, 2007

(54) FILM MANAGEMENT METHOD

(76) Inventor: Yamagata Hiroshi, Kanagawa (JP)

Correspondence Address: Pamela R. Crocker;Patent Legal Staff, Eastman Kodak Company, 343 State Street, Rochester, NY, 14650-2201, US

(21) Appl. No.: 11/535,655

(22) Filed: Sep. 27, 2006

(30) Foreign Application Priority Data
Jan. 27, 2006 (JP) 2006-018623

(51) Int. Cl. G06F 12/14

(52) U.S. Cl. 713/187

(57) ABSTRACT

An image file is managed more appropriately. When an image file is transferred from a camera to a server, a determination is made in advance as to whether or not an image file exists in both the camera and the server. When matching of image files is determined, an image file having the same file size is first identified. When an image file having the same size is present, partial hash values summarizing initial portions of the image files are then calculated. The partial hash values are compared with each other. When a match exists between the partial hash values, total hash values summarizing the entire image files are further calculated, and the total hash values are compared with each other. An image file having all of the same file size, the same partial hash value, and the same total hash value is determined to be an identical file. In contrast, the image file that is not matched in terms of any one of the three factors is determined to be another file, a request for transmission of the image file is sent to the camera.

### CROSS REFERENCE TO RELATED APPLICATIONS

This application claims priority to Japanese Patent Application No. 2006-018623 filed on Jan. 27, 2006, which is incorporated herein by reference in its entirety.

### FIELD OF THE INVENTION

The present invention relates to a method for managing image files created according to a predetermined format.

### BACKGROUND OF THE INVENTION

In recent years, digital cameras capable of acquiring captured images as digital files have come into wide use. Image files created by such a digital camera are stored in another information processing device (a server) as well as in memory provided in the digital camera. The image files stored in memory of comparatively small storage capacity are transferred to the server, as required, thereby ensuring free space in the memory.

Creating another image file from one image file has recently been carried out. For instance, an image file having a small number of pixels is created from an image file having a large number of pixels.

Under the present circumstances, there are many cases where image files captured by the digital camera are stored in a plurality of locations in a dispersed manner, and where other image files relevant to one image file are present. In such a situation, difficulty is encountered in appropriately managing image files.

For instance, when image files are stored in a plurality of locations in a dispersed manner, there may arise a desire to determine the locations of image files stored in the plurality of locations in an overlapping manner. However, there is a possibility of details of the image files stored in the digital camera or the server being altered, as required, according to a user command. Therefore, the locations of overlapping files cannot be determined by means of only comparing file names, ID numbers, or the like, of the image files. Comparing the image files enables accurate location of overlapping files. However, in such a case, the image files must be exchanged between different devices by way of communications means. Exchange of the image files involves consumption of much time, which imparts an unpleasant feeling to the user.

Further, difficulty is often encountered in identifying a relation between an image file having a large number of pixels and an image file having a small number of pixels created therefrom; namely, a set relationship. An image file having a large number of pixels and an image file having a small number of pixels are basically different files, and hence a set relationship cannot be identified by a mere comparison of files. Identifying a set relationship on the basis of a file name and an ID number is also conceivable. However, there may arise a case where the user alters a file name or details of an image file having a large number of pixels. In such a case, the set relationship cannot be identified by a file name, an ID number, or the like.

Japanese Patent Laid-Open Publications No. Hei-7-295867 and 2004-193692 describe techniques for facilitating file management. Japanese Patent Laid-Open Publication No. Hei-7-295867 describes transmission of only a difference between two files when a receiving-end computer has a reference file analogous to a source file transmitted from a transmission-end computer. The difference is identified by means of respectively dividing the source file and the reference file into a plurality of blocks; acquiring keys (values of respective bytes of data pertaining to a block) for each block; and comparing the keys of corresponding blocks with each other.

Japanese Patent Laid-Open Publication No. 2004-193692 describes an image-capturing device for storing current information showing a destination where captured images are to be stored. Current information stored in an image-capturing device and the up-to-date current information stored in a server are compared with each other every time power is turned on. Only when a mismatch exists between the pieces of current information, the up-to-date current information is acquired from the server. When the pieces of current information are compared with each other, a hash value of the current information stored in the image-capturing device and a hash value of the current information stored in the server are compared to each other.

These techniques enable shortening of the time required to establish communication between different devices and appropriate management of tiles. However, the technique described in Japanese Patent Laid-Open Publication No. Hei-7-295867 is limited to a case where a receiving-end computer has a reference file analogous to a source file to be transmitted and that reference file can be distinctly identified. Further, in Japanese Patent Laid-Open Publication No. 2004-193692, only one current file being present in a digital camera and only one current file being present in a server are handled as objects of comparison. These techniques are hardly applicable to a case where an overlapping image file is identified from among a plurality of image files being present in different devices. The techniques are also hardly applicable to a case where a set relationship among the image files is to be determined.

### SUMMARY OF THE INVENTION

Therefore, the present invention provides a file management method which enables more appropriate management of image files.

The present invention provides a file management method for managing an image file created in accordance with a predetermined format, the method comprising:

obtaining a hash value of at least an initial portion of an image file as a partial hash value; and

taking the obtained partial hash value as a key for identifying the image file, to thus manage a file. The term “image file” used herein means either a still image file or a moving image file.

In a preferred mode, the initial portion includes at least a thumbnail image data portion. Moreover, the initial portion is preferably of data size from an initial area of the image file acquired through single I/O operation. A partial hash value is preferably a hash value of an initial portion and bottom portion of an image file.

In another preferred mode, the file management method further includes, for a case where there is determined existence of a match between a camera-side image file stored in a camera and a server-side image file stored in a server mutually-communicable with the camera, a step of the camera calculating a partial hash value of the camera-side image file as a camera-side partial hash value;

a step of the server calculating a partial hash value of the server-side image file as a server-side partial hash value;

a step of sending and receiving the camera-side partial hash value and the server-side partial hash value between the camera and the server in order to collect the hash values in either the camera or the server; and

a step of determining existence of a match between the camera-side image file and the server-side image file on the basis of a result of comparison of the collected partial hash values.

In this case, the partial hash value is preferably calculated every time determination of matching of image files is instructed. The partial hash values are preferably collected in the server, and the server preferably compares the partial hash values to thus determine matching of the files. Further, attribute information about the camera-side image file and attribute information about the server-side image file are preferably compared with each other prior to comparison of the partial hash values. The partial hash values are preferably compared with each other in connection with only an image file having matched attribute information. The attribute information includes any one of a file size of each of image files, a date of creation of the image file, and conditions for photographing an image.

In another preferred mode, the file management method further includes, for a case where relevance between an image file of high resolution and an image file of low resolution created from the image file of high resolution is identified,

a step of previously calculating a partial hash value of an image file of high resolution as a first partial hash value, and storing the calculated first partial hash value in association with an image file of low resolution corresponding to the image file of high resolution;

a step of calculating a partial hash value of an image file of high resolution as a second partial hash value at the time of identification of relevance; and

a step of identifying relevance between the image file of high resolution and the image file of low resolution, on the basis of a result of comparison between the calculated second partial hash value and the first partial hash value associated with the image file of low resolution.

According to the present invention, a partial hash value summarizing at least an initial portion of an image file is taken as a key used for identifying the image file, to thus manage a file. As is well known, a high degree of uniqueness is guaranteed for a hash value according to contents of data. As a result of such a hash value being used as an identification key, whether or not changes have been made to contents of an image file can be readily ascertained, and hence files can be appropriately managed. Further, data closely relating to contents of an image file, including thumbnail image data, are recorded in the initial portion of the image file, but the data are of small volume. Using a hash value in such an initial portion enables shortening of a time required to calculate a hash value and appropriate management of files.

The invention will be more clearly comprehended by reference to the embodiments provided below. However, the scope of the invention is not limited to those embodiments.

### BRIEF DESCRIPTION OF THE DRAWINGS

Preferred embodiments of the present invention will be described in detail based on the following figures, wherein:

FIG. 1 is a block diagram showing a diagrammatic configuration of a camera system which is an embodiment of the present invention;

FIG. 2 is a view showing a format of an image file;

FIG. 3 is a flowchart showing the flow of transfer of an image file from a camera to a server;

FIG. 4 is a conceptual rendering showing the manner of managing image files according to another embodiment;

FIG. 5 is a flowchart showing flow of processing from capturing of an image to storage of an image file; and

FIG. 6 is a flowchart showing flow achieved when a print command has been received via the camera.

### DETAILED DESCRIPTION OF THE PREFERRED EMBODIMENT

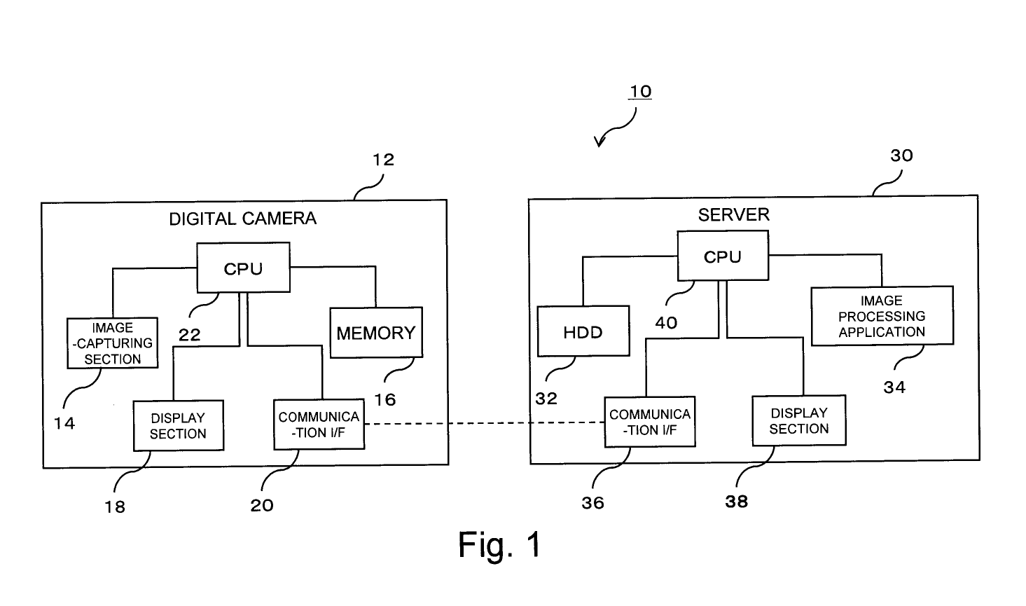

An embodiment of the present invention will be described hereinbelow. FIG. 1 is a block diagram showing the diagrammatic configuration of a camera system 10 which is an embodiment of the present invention. This camera system 10 is generally divided into a digital camera 12, and a server 30 capable of establishing mutual communication with the digital camera 12.

In accordance with a command from the user, an image-capturing section 14 of the digital camera 12 performs image-capturing operation, as required, to thus create a digital image file. The specific configuration of the image-capturing section 14 is analogous to a known digital camera, and hence explanation thereof is omitted. The thus-created image file is stored in memory 16 and also displayed on a display section 18, as required. The display section 18 displays the captured image, as required. Upon glancing at the image appearing on the display section 18, the user can determine whether or not the captured image is good. The memory 16 may be fixedly built in the camera, or removably attached to the camera as in the case of a memory card and the like. Image files acquired through image-capturing actions are sequentially stored in the memory 16. However, the memory is usually smaller in storage capacity than a hard disk drive (HDD) of a server to be described later, and difficulty is encountered in storing a large number of image files into the memory. This being the case, the digital camera 12 is configured so as to be able to transfer the image files stored in the memory 16 to the server, as appropriate. Communication with the server is realized by a communications interface (I/F) 20. This communications I/F 20 provides the digital camera with a communications capability. The communications capability to be provided may be any one of communications capabilities such as a wired communications capability such as RS-232C and a wireless communications capability such as Bluetooth and the like. A CPU 22 controls the above-described individual sections, and performs various arithmetic operations or output of a command to the individual sections as necessary.

The server 30 is an information processing apparatus capable of storing image files created by the digital camera 12. This server 30 has a communications I/F 36 compatible with the communications I/F 20 of the digital camera 12, and can establish mutual communication with the digital camera 12. The server 30 is also equipped with a hard disk drive (HDD) 32 used for storing the image files transmitted from the digital camera 12. This HDD 32 is larger in storage capacity than the memory 16 of the previously-described digital camera 12, and can store a large number of image files. Like an ordinary information processing apparatus, various types of applications are installed in the server 30. An image processing application is conceivable as one of the applications to be installed. An image processing application 34 is for subjecting various types of image files, including the image file transmitted from the digital camera 12, to various image processing operations; for example, synthesis processing, color correction, trimming, and the like. By utilization of the image processing applications, the user can acquire an image file more complying with a desire. A CPU 40 controls the individual sections, and performs various arithmetic operations or outputs a command to the individual sections, as necessary. File match determination processing, which will be described later, is also executed by the CPU 40. A display section 38 of the server 30 displays information, an image, and the like, which are to be provided for the user, as required.

Management of image files in such a camera system 10 will be briefly described. As has been described previously, the image file created by means of image-capturing operation of the digital camera 12 is stored in the memory 16 of the camera 12. However, the memory 16 has comparatively-small storage capacity, and hence cannot store a large number of image files. Accordingly, the user transfers the image files stored in the memory 16 to the server 30, as appropriate, thereby ensuring free space in the memory 16.

At that time, the image files to be transferred are limited solely to the image files which are not present in the server 30. Put another way, the image files stored in both the server 30 and the digital camera 12 are not transferred again but are deleted. This is for curtailing a communication time required to transmit overlapping image files. Recently, the number of pixels of the digital camera 12 is increased, and the volume of data pertaining to a captured image file has become very large. As the volume of data pertaining to an image file becomes greater, the time required for data transmission becomes longer. In order to curtail, even slightly, the number of operations for transferring image files and shorten, even slightly, a total communication time, in the present embodiment the image files overlapping between the camera 12 and the server 30 are not transferred.

In order to prevent transfer of overlapping image files as mentioned above, overlapping image files must be naturally identified. The image file created by the digital camera 12 is naturally imparted with identifiers such as a file name, an ID number, and the like. In order to compare the identifiers, an overlapping image file can be identified to some extent. However, there is a high probability of the user altering a file name, and the like, and overlapping files cannot be accurately identified by means of only the file name, and the like. Further, even when the file name, and the like, is not altered, there may be a case where image data themselves are altered. Specifically, the image processing application 34 is installed in the server 30 as mentioned previously, and there is a case where image processing is performed by means of the application, to thus alter the file to another file of different contents. Moreover, a simple image processing application is installed in the camera 12, as well. There may be a case where image data are subjected to simple image processing; e.g., trimming, rotation, and the like, in only the camera. When image data have undergone such image processing, the overlapping file cannot be identified by means of only a file name and the like.

Consequently, in order to identify an image file overlapping between the camera 12 and the server 30, details of each of the files must be compared in detail. However, when the image file is transferred to the server 30 for comparison, transfer time becomes enormous, which is not practical.

In order to solve the problem, in the present embodiment, a hash value which serves as a summary of an image file rather than the image file is compared, to thus identify an overlapping image file. Thus, unnecessary transfer of an image file can be prevented.

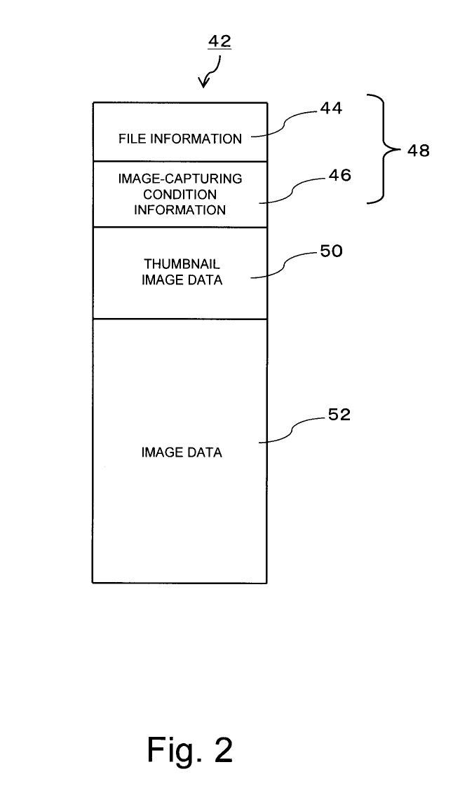

Before identification of an overlapping file using a hash value is described, a format of an image file will be briefly described. The format which is described below is an example. As a matter of course, another type of format may also be adopted. Only the format of a still image file is described herein. As to a moving image file, various standardized formats are available. The present embodiment can also be applied to management of moving image files prepared in consonance with such a predetermined format. FIG. 2 is a view showing an example format of a still image file 42. The format of the image file 42 created by the digital camera 12 is generally defined by standards. The digital camera 12 of the present embodiment also creates the image file 42 in accordance with the format complying with the standards. As shown in FIG. 2, header information 48, thumbnail image data 50, and main image data 52 are recorded, in sequence from the top, in the thus-created image file 42.

The header information 48 consists of various pieces of information relating to the image file 42, and includes file information 44 about the number of pixels of the main image data 52 and a compression format, image-capturing condition information 46 about a date and time of capture of the main image data 52, the model name of a camera used for photography, an “f” number, and the like. The thumbnail image data 50 correspond to image data formed by reducing the main image data 52, and are utilized when contents of the plurality of image files 42 are displayed in list form. Regardless of the number of pixels of the main image data 52 to be described later, the thumbnail image data 50 are defined to be 160×120 pixels at all times. The main image data 52 are data pertaining to an image captured through image-capturing action.

Among the header information 48, the thumbnail image data 50, and the main image data 52 are naturally of the largest data size, and in many cases the data size of the main image data 52 comes to several megabytes to hundreds of megabytes. Meanwhile, the data size of a head portion exclusive of the main image data 52; namely, the total of data size of the header information 48 and the data size of the thumbnail image data 50, is small. A total of the data sizes of the header information 48 and the thumbnail image data 50 is of several kilobytes to tens of kilobytes or thereabouts. However, the initial portion includes a thumbnail image. When a match exists between initial portions of image files, there is a high probability of both image files being the same image file.

Accordingly, in the present embodiment, partial hash values are obtained by application of a hash function to the initial portions of the image files 42. The thus-obtained hash values are compared with each other, to thus identify matching of the image files 42. At this time, the partial hash values can be obtained by application of the hash function solely to a portion of 16 kilobytes (16K range) from the head of the image file 42. 16 kilobytes correspond to a data size which can be fetched by a single I/O operation. Consequently, the data which are an object of the partial hash value are limited to a volume of 16 kilobytes, whereby a partial hash value can be obtained by a single I/O operation, thereby shortening the time required to calculate the partial hash value. The header information 48 and the thumbnail image data 50 usually fall within a data range which is an object of a partial hash value; namely, a 16K range from the head of a file.

When matching of the files cannot be determined by means of only comparison of the partial hash values, the hash function is applied to the entire image file 42, thereby calculating total hash values. A match is more strictly determined on the basis of a comparison between the thus-calculated total hash values.

The hash values used for determining a match are calculated immediately before a match is rendered. Specifically, once-calculated hash values are not retained at all times, but hash values are newly calculated every time a match is determined. A hash value is calculated every time a match is determined, whereby a hash value reflecting contents of an altered file can be obtained even when file contents have been altered since the previous determination of a match. Hence, a match can be determined more accurately.

Even a partial hash value obtained by application of the hash function solely to the initial portion of the image file 42 poses a certain degree of load on calculation thereof. Particularly, the CPU of the digital camera 12 often has a comparatively low processing capability. There are many cases where calculating partial hash values of all image files stored in the memory 16 poses a burden on the CPU. In the present embodiment, as will be described in detail later, file sizes are compared with each other prior to comparison of the hash values. In relation to only image files whose file sizes match each other, hash values of the image files are compared. The volume of calculation of a hash value can be diminished, and overlapping image files can be identified more quickly.

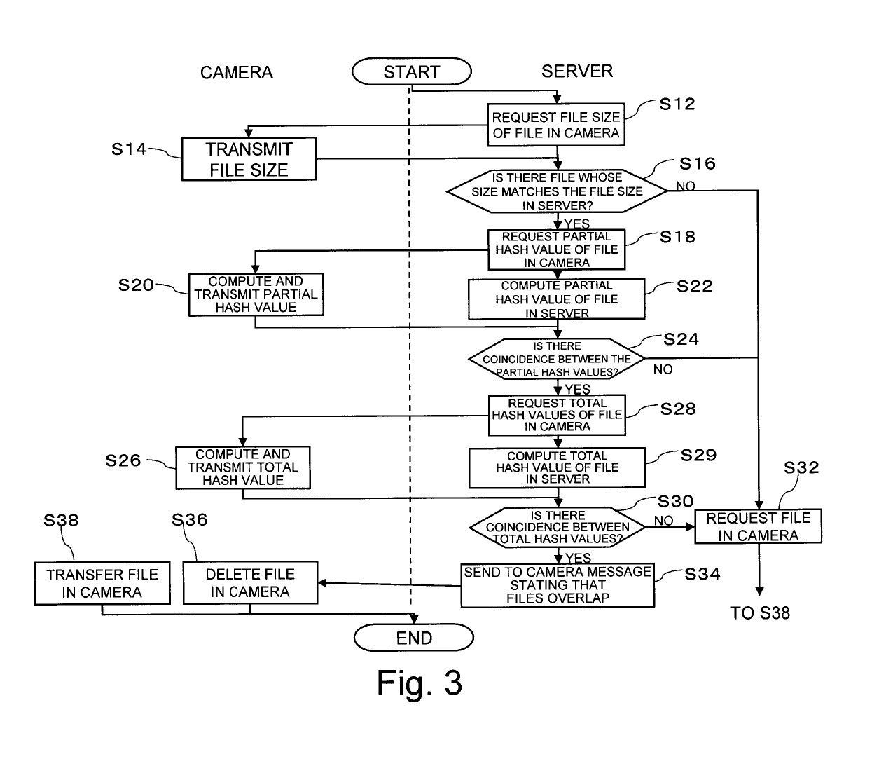

Flow of transfer of an image file performed by the camera system 10 will now be described in detail. FIG. 3 is a flowchart showing the flow of one image file from the camera 12 to the server. In FIG. 3, processing specifics of the camera 12 are described on the left side, and processing specifics of the server 30 are provided on the right side. In the following descriptions, image files stored in the memory 16 of the camera 12 are called “camera-side files,” and image files stored in the HDD 32 of the server 30 are called “server-side files.”

Upon receipt of a command for transferring a camera-side file from the user, the server 30 first requests the camera 12 to transmit a file size of the camera-side file (S12). In response to the request from the server 30, the camera 12 transmits the file size of the camera-side file to the server 30 (S14). The server 30 having received the file size searches server-side files stored in the HDD 32, to thus determine whether or not the a server-side file whose file size matches the transmitted file size (S16). When a server-side file having the same file size as does the camera-side file is not found, no server-side file overlapping the camera-side file for which transfer has been instructed can be determined to be present. Consequently, in that case, the server 30 requests the camera 12 to transmit the camera-side file (S32). Pursuant to the instruction from the camera 30, the camera 12 transfers the camera-side file to the server 30 (S38).

When a server-side file having the same file size as that of the camera-side file is found, there is a possibility of both files being the same file. Therefore, the server 30 further determines matching of the files on the basis of comparison of hash values of the files (S18 to S30). More specifically, the server 30 send to the camera 12 a request for a partial hash value of the camera-side file (Si 8). The server 30 calculates a partial hash value of the server-side file having the same file size as that of the camera-side file identified in S16 (S22). Meanwhile, the camera 12 having received the request for a partial hash value calculates the partial hash value of the camera-side file and transmits the thus-calculated partial hash value to the server (S20).

The server 30 having acquired the partial hash value of the camera-side file and the partial hash value of the server-side file compares the partial hash values with each other (S24). As is well known, a hash value is made by summarizing designated data by use of a mathematical function (a hash function); is unique for each item of data to be summarized; and is deemed to differ from one item of object data to another item of object data. Consequently, when a match exists between the partial hash value of the camera-side file and the partial hash value of the server-side file, the initial portions of the files are identical with each other with considerably high probability. The probability of the initial portions including the previously-described thumbnail images and the two image files, which have matched initial portions including the thumbnail images, matching with each other can be said to be high to some extent. When the partial hash value of the camera-side file matches the partial hash value of the server-side file, the probability of the files being the same can be said to be high to some extent. In this case, in order to determine matching of the files in a more strict manner, processing proceeds to step S28. Conversely, when no match exists between the partial hash values, the files can be determined to be unmatched. In this case, the server 30 requests the camera 12 to transmit the camera-side file (S32).

When a match exists between the partial hash portion of the camera-side file and the partial hash portion of the server-side file, the server 30 sends to the camera a request for total hash values of the camera-side files (S28). Total hash values of the server-side file corresponding to the camera-side file are calculated (S29).

The camera 12 having received the request for total hash values calculates total hash values of the designated camera-side files, and transmits the calculated hash values to the server 30 (S26). The server 30 compares all the hash values transmitted from the camera 12 with all the hash values of the corresponding server-side file (S30). As a result, when the two total hash values have not matched, the server 30 requests the camera to transfer the camera-side file (S32). Meanwhile, when a match exists between the two sets of hash values, the server 30 determines the server-side file and the camera-side file to be identical. A notification to this effect is sent to the camera (S34). The camera having received the notification deletes the camera-side file stored in the memory 16 without transferring the same to the server (S36). Thus, transfer processing ends.

As is obvious from the above descriptions, in the present embodiment, matching of the image files is determined from file sizes and hash values prior to transfer of the image files. As a result, unwanted transmission of the image file can be prevented. Further, the file sizes and the hash values transmitted for determining a match are considerably smaller than in data size than an image file itself. Therefore, a match can be determined within a period of time which is shorter than that during which an image file itself is transmitted.

In the embodiment, a comparison of file sizes is performed prior to a comparison of hash values. Consequently, unwanted calculation of hash values can be prevented, and the time required to transfer an image file can be shortened further.

As is evident from the flowchart shown in FIG. 3, in the present embodiment the server 30 rather than the camera 12 performs a comparison of file sizes and a comparison of hash values. In many cases, the server 30 is usually higher in processing capability than the camera 12. The server 30 is caused to perform various comparisons, thereby lessening a load on the camera 12 and, by extension, a time required to determine matching of files.

Although the described flow is an example, the flow may be modified, as required, so long as at least partial hash values are compared with each other. For instance, in the present embodiment, when a match exists between the partial hash values, comparison of total hash values is also performed in order to make a strict determination of a match. However, when the time required to determine a match is desired to be further shortened, comparison of total hash values may be omitted, and an image file having the same partial hash value may be deemed to be an identical file. In the present embodiment, comparison of file sizes is performed prior to comparison of partial hash values, but the comparison may be omitted. Alternatively, pieces of attribute information other than the file size; for example, a file name, an ID number, data showing where an image file has been created, a date and time when an image has been captured, and the like, may be compared with each other. In the present embodiment, a hash value in the initial portion of an image file is handled as a partial hash value. However, the hash function may be applied to the initial portion of an image file and the bottom portion thereof, and these portions may be handled as partial hash values. By means of reflecting information about the bottom portion to the partial hash values, the possibility of an imperfectly-transferred image file being determined to be an identical file can be diminished.

Another embodiment will now be described. In the previously-described embodiment, matching of image files of the same format is determined. However, in some occasions, there is a case where a match (or relevance) between image files of different formats is desired to be determined.

For instance, as mentioned previously, the ordinary digital camera 12 is provided with the display section 18, and can display image files stored in the memory 16. However, the display section 18 provided in the digital camera 12 often has a low resolution. An image file to be displayed on such a display section 18 does not need to be of high resolution. Meanwhile, when processing such as printing is performed, the image files are to be of high resolution. Processing such as printing is executed by the server 30, which is an information processing apparatus. Hence, so long as the server 30 has an image file of high resolution, the camera 12 does not need to have an image file of high resolution.

Accordingly, it can be conceived to store an image file of high resolution into the file server 30 and to store only an image file of low resolution created from the image file of high resolution into the memory 16 of the camera 12. As a result of this, there is yielded an advantage of the ability to preserve a plurality of image files into the memory 16 of the camera 12 having comparatively-low storage capacity. However, this method encounters a problem of difficulty in understanding relevance between the image file of low resolution stored in the camera 12 and the image file of high resolution stored in the server 30.

For instance, thought is given to a case where the user designates an image file to be printed by way of the camera 12. In this case, the user displays an image file of low resolution stored in the memory 16 on the display section 18 of the camera 12, to thus ascertain details of respective image files and designate an image file to be printed. The camera 12 outputs, to the server 30, a command to print an image file of high resolution corresponding to the image file of low resolution instructed by the user (i.e., an original image file which is the source of the image file of low resolution). The server 30 having received the print command identifies the original image file of high resolution corresponding to the image file of low resolution designated by the user, and performs print processing. However, at this time, the image file of low resolution instructed by the user and the corresponding original image file of high resolution totally differ from each other in terms of formats. Difficulty is encountered in identifying the original image file.

As a matter of course, so long as identifiers showing relevance are imparted to the image file of low resolution and the corresponding original image file and relevance between the image files is stored in the form of a list, a corresponding original image file can be identified to some extent. However, as mentioned previously, there is a case where contents of the image files stored in the server 30 are altered as required by utilization of the image processing application 34 or the like. In such a case, it is difficult to identity relevance between the image file of low resolution and the original image file on the basis of previously-described identifiers and list.

For these reasons, in the present embodiment, a hash value is utilized for identifying relevance between two image files of different formats. Specifically, when an image file of low resolution is created from an image file of high resolution, a hash value of the image file of high resolution is also calculated. The thus-created image file of low resolution and the hash value are stored in the memory 16 of the camera 12 in an associated manner. When a corresponding image file of high resolution is identified on the basis of the image file of low resolution, a hash value of the image file of high resolution stored in the server 30 is again created. The image file of high resolution having the same hash value as the hash value associated with the designated image file of low resolution is identified as a corresponding original image file.

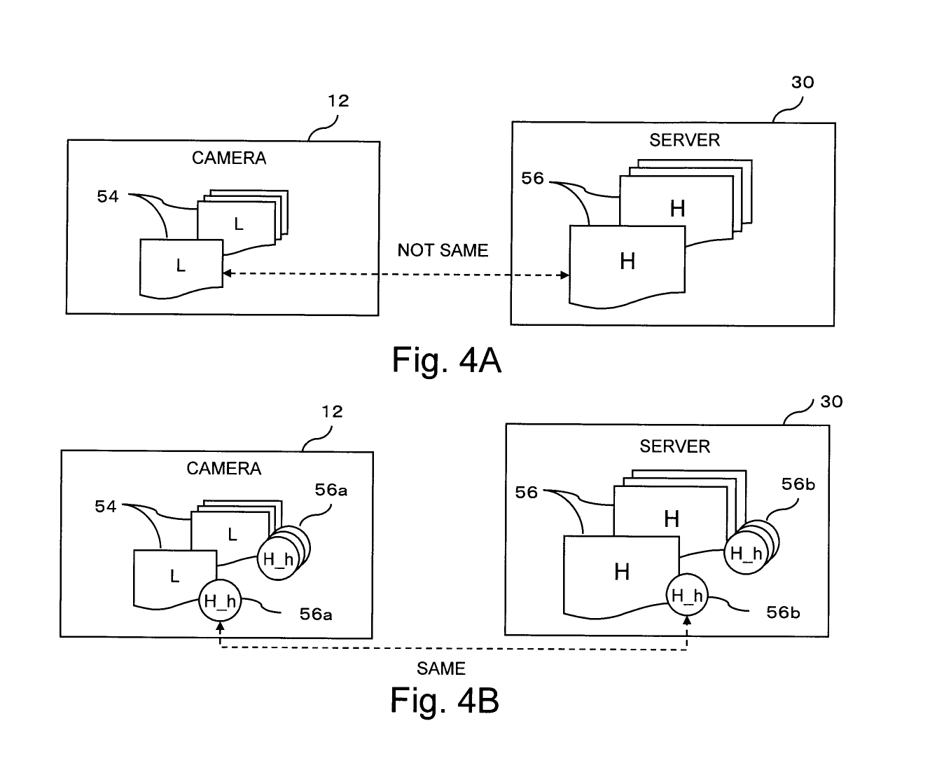

Identification of relevance between the image file of high resolution and the image file of low resolution will now be described by reference to FIGS. 4A and 4B. As shown in FIG. 4A, an image file 56 of high resolution is assumed to be stored in the server 30, and an image file 54 of low resolution created from the image file 56 of high resolution is assumed to be stored in the camera 12. In this case, the image file 54 of low resolution stored in the camera 12 and the image file 56 of high resolution stored in the server 30 are of different formats, and hence a match does not exist between these image files. Consequently, identifying the original image file of high resolution from the image file of low resolution is difficult.

Accordingly, in the present embodiment, a hash value 56a of the original image file is calculated at the time of creation of the image file of low resolution, and the thus-calculated hash value 56a is stored in the camera 12 while being associated with the image file of low resolution. When the original image file corresponding to the image file 54 of low resolution is identified, the hash value 56a associated with the image file 54 of low resolution; namely, a hash value 56a created at the time of creation of an image file of low resolution, is compared with a hash value 56b of the image file 56 of high resolution created at the time of identification. When the original image file is not altered, a match exists between the hash value 56a created at the time of creation of the image file of low resolution and the hash value 56b created at the time of identification of the original image file. Therefore, by means of matching of the hash values 56a, 56b, an original image file corresponding to the image file 54 of low resolution can be identified with considerable reliability.

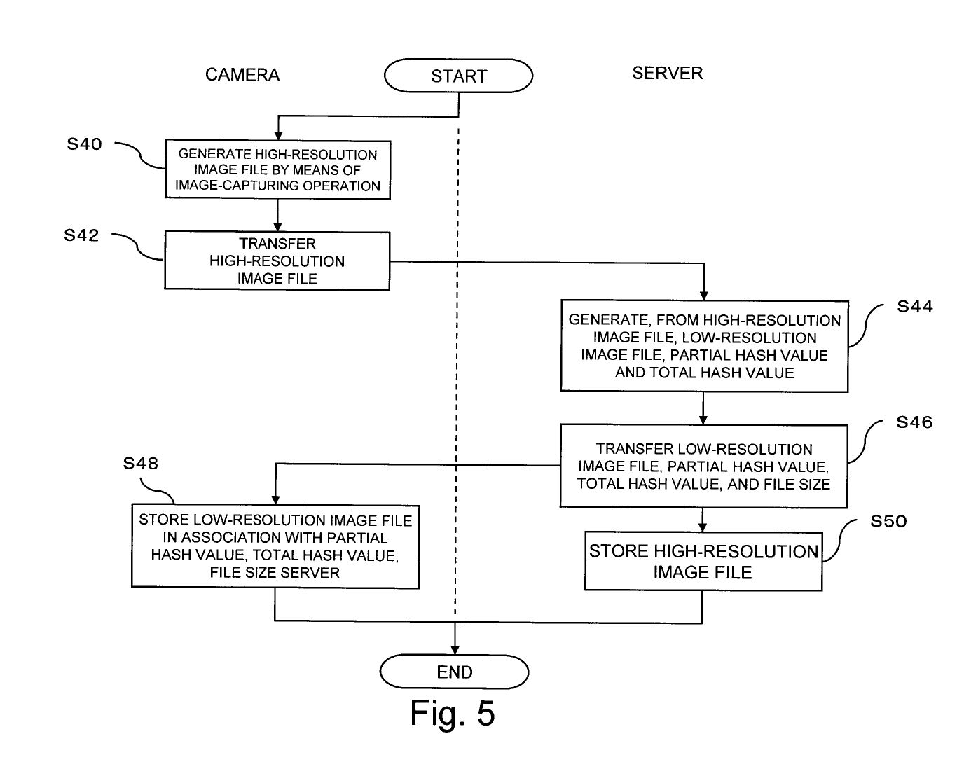

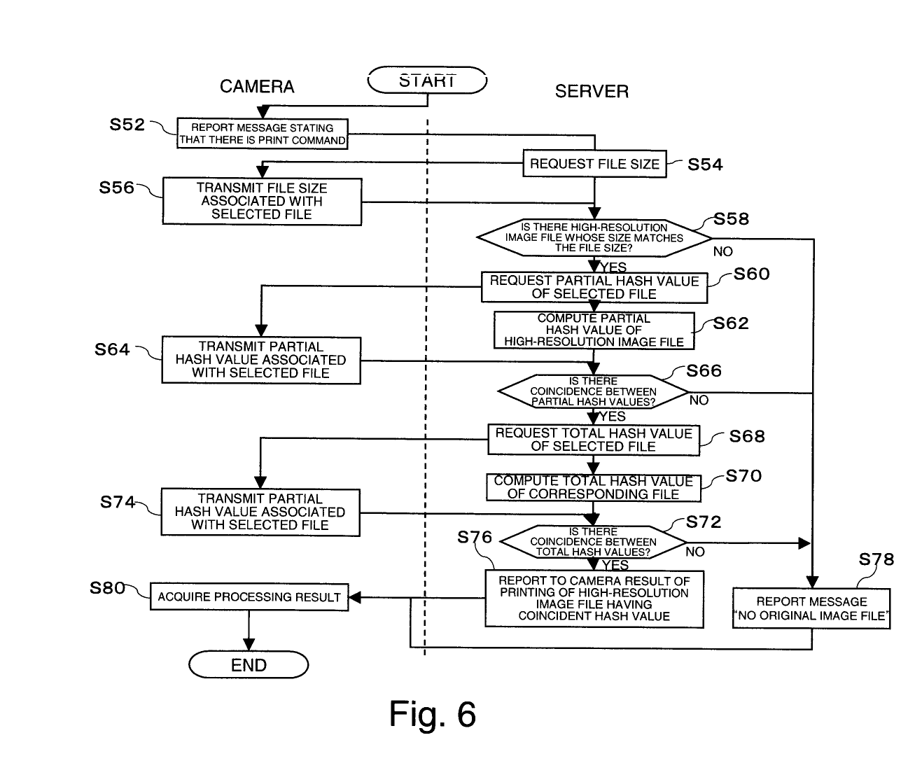

Flow of identification of relevance between the image file of low resolution and the original image file will now be described by reference to FIGS. 5 and 6. FIG. 5 is a flowchart showing the flow of processing from capturing of an image to recording of an image file. FIG. 6 is a flowchart showing the flow of processing for identifying an original image file corresponding to an image file of low resolution designated by the user.

Upon receipt of an image-capturing command from the user, the digital camera 12 performs image-capturing operation, to thus create an image file (S40). An image file to be created is an image file of high resolution. Generally, the created image file of high resolution is temporarily stored in the memory 16 of the camera 12. Storage of this image file is temporary. When communication with the server 30 can be established, this image file of high resolution is transferred to the server 30 (S42). The server 30 having received the image file of high resolution calculates, from the image file of high resolution, an image file of low resolution, a partial hash value of the image file of high resolution, and total hash value of the image file of high resolution (S44). The image file of low resolution is an image file created by decreasing the number of pixels of the image file of high resolution; namely, an image file having the number of pixels complying with the number of pixels of the display section 18 of the camera 12. As in the case of the previously-described embodiment, the partial hash value is obtained by application of the hash function solely to the initial portion of the image file of high resolution, and the total hash value is obtained by application of the hash function to the entire image file of high resolution.

Subsequently, the server 30 transfers to the camera the thus-created image file of low resolution, the two types of hash values, and the file size of the image file of high resolution (S46). The image file of high resolution is stored in its present form in the HDD 32 of the server 30 (S50). Meanwhile, the camera 12 stores the received image file of low resolution into the memory 16 while associating the same with the hash value of the image file of high resolution and a file size (S48).

Through the above flow of processing, only the image file of low resolution, the hash value, and the file size are stored in the memory 16 of the camera 12 having small storage capacity. The image file of low resolution, the hash value, and the file size are significantly smaller in data size than the image file of high resolution, and hence a large number of image files can be stored in the memory 16 of the camera 12.

There will now be described flow of processing performed when an image file to be printed is designated by the user via the camera 12. When the user has issued a printing command via an image file of low resolution to be displayed on the display section of the camera 12, the camera 12 sends a notification to this effect to the server 30 (S52). The server 30 having received the notification sends to the camera 12 a request for a file size of the image file of high resolution associated with the image file of low resolution for which the print command has been issued (S54).

In response to the request, the camera 12 transmits to the server 30 a file size associated with an image file of low resolution selected by the user (S56). The server 30 determines whether or not an image file of high resolution having the same file size as that transmitted from the camera 12 is stored in the HDD 32 (S58). When the image file of high resolution having the same file size is not stored, the server 30 determines that an image file of high resolution which is the source of the selected image file of low resolution is not present, and sends a notification to this effect to the camera 12 (S78).

When the image file of high resolution having the same file size is stored in the HDD 32, the server 30 determines relevance more accurately. Specifically, the server 30 sends to the camera 12 a request for a partial hash value associated with the selected image file of low resolution (S60). Further, the server 30 calculates a partial hash value of the image file of high resolution whose file size has been determined to be the same in step S58 (S62). In response to the request from the server 30, the camera 12 transmits to the server 30 a partial hash value associated with the selected image file of low resolution (S64). The server 30 determines whether or not a match exists between the partial hash value transmitted from the camera 12 and the partial hash value re-calculated from the image file of high resolution (S66).

When no match exists between the partial hash values, the server 30 notifies the camera 12 that an original image file (an image file of high resolution) corresponding to the image file of low resolution designated by the user is not present (S78). When a match exists between the partial hash values, the server 30 sends to the camera 12 a request for a total hash value associated with the image file of low resolution designated by the user (S68). Concurrently, the server 30 calculates the total hash value of the image file of high resolution having the same hash value (S70).

The camera 12 having received a request for a total hash value transmits to the server 30 a total hash value associated with the image file of low resolution selected by the user (S74). The server 30 compares the calculated total hash value with the hash value transmitted from the camera 12, to thus determine whether or not a match exists between the hash values (S72). When a match exists between the hash values, the image file of high resolution is determined to be an original image file corresponding to the image file of low resolution designated by the user, and printing of the image file is performed (S76). In contrast, when no match exists between the image files, the server 30 notifies the camera 12 that the original image file corresponding to the image file of low resolution designated by the user is not present (S78).

In both the case where print processing has been performed (S76) and the case where the original image file is determined not to be present (S78), the server 30 notifies the camera 12 of the result of processing. Upon acquisition of the result of processing (S80), the camera 12 provides the user with the processing result via a display screen or the like.

As has been described above, according to the present embodiment, relevance between the image files of different formats can be identified. During the course of identification, the partial hash value calculated in the past is compared with the hash value calculated at the time of identification of relevance. Therefore, there is prevented erroneously determination of existence of relevance, which would otherwise be caused when contents of the image file are altered after initial calculation of the hash value. Consequently, appropriate management of files becomes possible. The above-described identification method is an example and may be changed as required. For instance, in the above embodiment, file sizes are compared with each other prior to comparison of partial hash values. However, this comparison may be omitted. Although the partial hash value is compared with the total hash value, it may be the case that only partial hash values are compared with each other, and comparison of total hash values is omitted.

### PARTS LIST

10 camera system
12 digital camera
14 image-capturing section
16 memory
18 display section
20 communications interface (I/F)
22 CPU
30 server
32 hard disk drive (HDD)
34 image processing application
36 communication I/F
38 display section
40 CPU
42 image file
44 file information
46 image-capturing information
48 header information
50 thumbnail image data
52 main image data
54 image file
56 image file
56a hash value
56b hash value
S12 camera-side file
S14 server
S16 file size
S18-S30 hash values
S18 camera-side file
S20 erver
S22 camera-side file
30 server side file
S32 camera-side file
S34 camera
S36 server
S38 server
S40 image file
S42 image file
S44 high resolution
S46 high resolution
S48 file size
S50 image file
S52 message
S58 step
S60 hash value
S62 hash value
S64 hash value
S66 hash value
S68 hash value
S70 hash value
S72 hash value
S74 hash value
S76 image file
S78 message
S80 processing result

1. A file management method for managing an image file created in accordance with a predetermined format, the method comprising:
obtaining a hash value of at least an initial portion of an image file as a partial hash value; and
taking the obtained partial hash value as a key for identifying the image file, to thus manage a file.

2. The file management method according to claim 1, wherein the initial portion includes at least a thumbnail image data portion.

3. The file management method according to claim 1, wherein the initial portion is of data size from an initial area of the image file acquired through single I/O operation.

4. The file management method according to claim 1, wherein a partial hash value is a hash value of an initial portion and bottom portion of an image file.

5. The file management method according to claim 1, further comprising, for a case where there is determined existence of a match between a camera-side image file stored in a camera and a server-side image file stored in a server mutually-communicable with the camera, a step of the camera calculating a partial hash value of the camera-side image file as a camera-side partial hash value;
a step of the server calculating a partial hash value of the server-side image file as a server-side partial hash value;
a step of sending and receiving the camera-side partial hash value and the server-side partial hash value between the camera and the server in order to collect the hash values in either the camera or the server; and
a step of determining existence of a match between the camera-side image file and the server-side image file on the basis of a result of comparison of the collected partial hash values.

6. The file management method according to claim 5, wherein the partial hash value is calculated every time determination of matching of image files is instructed.

7. The file management method according to claim 5, wherein the partial hash values are collected in the server, and the server compares the partial hash values to thus determine matching of the files.

8. The file management method according to claim 5, wherein attribute information about the camera-side image file and attribute information about the server-side image file are compared with each other prior to comparison of the partial hash values, and
the partial hash values are compared with each other in connection with only an image file having matched attribute information.

9. The file management method according to claim 8, wherein the attribute information includes a file size of each of image files.

10. The file management method according to claim 1, further comprising, for a case where relevance between an image file of high resolution and an image file of low resolution created from the image file of high resolution is identified,
a step of previously calculating a partial hash value of an image file of high resolution as a first partial hash value, and storing the calculated first partial hash value in association with an image file of low resolution corresponding to the image file of high resolution;
a step of calculating a partial hash value of an image file of high resolution as a second partial hash value at the time of identification of relevance; and
a step of identifying relevance between the image file of high resolution and the image file of low resolution, on the basis of a result of comparison between the calculated second partial hash value and the first partial hash value associated with the image file of low resolution.
